(19) United States
(12) Patent Application Publication
(10) Pub. No.: US 2009/0260838 A1
(43) Pub. Date: Oct. 22, 2009

(54) System for protecting an object exposed to destructive elements

(76) Inventor: Thorsten Jungermann, Heilbronn (DE)

Correspondence Address: R. MICHAEL WEST;LAW OFFICES OF R. MICHAEL WEST, 1922 21ST STREET, SACRAMENTO, CA, 95811, US

(21) Appl. No.: 12/148,419

(22) Filed: Apr. 18, 2008

(51) Int. Cl. A62C 3/00

(52) U.S. Cl. 169/54

(57) ABSTRACT

A system for protecting an object such as a fixed structure or mobile structure, such as a mobile home, car, truck or the like, which is directly exposed to destructive elements from an outdoor fire, comprising a structured cladding of flexible, fireproof material attached to or overlying the exterior of the object in spaced relation is prefabricated substantially or at least correspondingly dimensioned to conform with the outer shape of the object and is capable of being deployed from a passive stowed condition in which the structured cladding is rendered compact in relation to the object, into an active protective condition in which the structured cladding is expanded to cover at least portion of the object.

### BACKGROUND OF THE INVENTION

The invention relates generally to a system for protecting an object, such as fixed or mobile structures, from exposure to destructive outdoor elements. The objects which may advantageously be protected through application of the present invention include homes, buildings, mobile homes, cars, trucks, and the like. The destructive elements range from natural weather elements such as the sun, wind, and rain, to more catastrophic sometimes man-caused elements, such as a forest fire or a structural fire in an adjacent home or building.

As evidenced from recent summers, communities formerly classified as having no or little risk of being destroyed by fire have suffered devastation from wild fires with increasing frequency. Several factors have contributed to this phenomenon, including the building of homes in heavily forested and remote areas, and the existence of widespread fuel caused by extended periods of drought.

Wild fires may have a natural cause, such as lightening. But more frequently, they are triggered by the act of an arson, a poorly managed controlled burn, or from the general negligence of leaving an unguarded camp fire or dropping burning cigarette butts or matches onto dry weeds or grasses. Because of the very high speed with which they spread, wild fires are a danger to man and other species alike. When such a wild fire approaches communities and structures which are directly exposed to the destructive elements, especially when driven by high winds, there is a considerable risk to human life. In addition, wild fires devastate homes, structures, and other objects in their path which cannot be moved, either because they are fixed or because there is no time to remove them from the approaching fire.

### SUMMARY OF THE INVENTION

The task of the present invention is to overcome the drawbacks of prior art, by effectively and economically preventing objects which are exposed to destructive elements, particularly wild fires, from suffering damage or being totally destroyed. This is accomplished without the necessity of removing the object from the endangered location, and without requiring expensive systems or complicated apparatus.

In accordance therewith, the fire protection system of the present invention comprises a structured cladding of flexible, fireproof material selectively deployed over the exterior surface of an object. The structured cladding is prefabricated substantially to conform to the shape and exterior dimensions of the object, so that it protects the exterior surfaces from heat, flame, and sparks generated by a fire.

Furthermore, the structured cladding is capable of being deployed from a passive, stowed condition in which the structured cladding is rendered compact on the object, into an active, protective condition in which the structured cladding is spread open, expansively to cover the object at least in part, and preferably completely. Thus deployed, the apparatus and method for using same described herein protect the object in situ, and prevent it from catching fire due to flying sparks or leaping flames. In addition, owing to its fireproof nature, the structured cladding serves as a flame retardant shield which the fire cannot penetrate.

The structured cladding may be configured as a single piece of fabric, or it may be comprised of a plurality of cladding pieces which are interconnected when deployed to protect the object. A number of embodiments and adaptations of the structured cladding are disclosed herein, to provide effective protection for objects varying greatly in size and configuration.

To achieve the desired fire resistant properties, the fireproof material preferably withstands heat of at least approximately 660° F. (approximately 350° C.). However, it is more desirable that the material comprising the structured cladding can withstand temperatures of 1100° F. (600° C.), and preferably temperatures of approximately 1800° F. (approximately 1000° C.). Depending on the heat anticipated for a particular circumstance, the material can be selected in accordance with its resistance to heat.

Owing to its flexible and heat resistant characteristics, the fireproof material may be a fabric composed of silicated fibers, preferably glass fibers. Materials particularly suitable for the protective structured cladding may be furnished in the form of high-temperature blankets such as, for example, the trademarked materials: isoTHERM® 1000, isoTHERM® 800, isoTHERM® HT, isoGLAS®, isokerum®, and isoTECH® preox needle-punched nonwovens made by the firm of Frezelit-Werke GmbH & Co. KG, IndustriestraBe 4, 95502 Himmelkron, Germany; CEPRO® KRONUS, CEPRO® ATLAS, CEPRO® PALLAS, CEPRO® HERCULES, CEPRO® SIRIUS and CEPRO® OLYMPUS made by the firm of CEPRO Deutschland GmbH, Dr.—Alfred-Herrhausen-Allee 20, 47228 Duisburg, Germany; proMEGA, proFIRE, proFEEK and proSAFE made by the firm of Ibena Textilwerke GmbH, Industriestraβe 7-13, 46395 Bocholt, Germany; and, Haceram fiber matting marketed by the firm HKO Isoliertechnik GmbH, Zum Eisenhammer 54, 46049 Oberhausen, Germany.

In one preferred embodiment of the invention, the structured cladding is formed by at least one web of fabric. For convenient storage, the structured cladding is rolled up or folded into stacked layers, to assume a compact configuration.

In another embodiment, a plurality of webs of fabric is provided. These webs may be formed by standardized web stock, for example, sized 10×4 meters or 20×3 meters. The webs of fabric can be joined together by means of wire, clips or fireproof cords. The ends of the webs of fabric directed toward the ground may be anchored to the ground. Providing a plurality of smaller and manageable webs of fabric makes it possible to install and remove an effective fireproof system rapidly, without outside help or reliance upon complicated mechanical fasteners.

Preferably, at least one web of fabric is folded for storage such that in its stowed condition, its plan dimensions are smaller or equal to the exposed surface of a roof of the object. The layer of the folded web of fabric facing the roof is secured to the roof or upper portion of the object. At least one further layer is releasably arranged facing the roof. Thus, when this further layer of fabric is deployed, any remaining surface areas of the roof or upper portion of the object which were uncovered are now covered, providing a complete protective condition for that surface area.

In a similar arrangement to the foregoing, which is designed additionally to protect the side or sidewalls of the object, the web of fabric comprises at least one two-layer fold, the total length of which when deployed is longer than the extent of a roof of a structure from the ridge to the eaves plus the height of the eaves from the ground adjacent the structure. In this manner, both the roof and the sides or sidewall of the object will benefit from the protection provided.

In another preferred aspect of the invention, the structured cladding comprises at least one web of fabric folded once, which is positioned on the roof of a structure such that the fold is located adjacent the eaves. A double-folded web of fabric comprises two layers folded on each other in the stowed condition, namely one layer facing the roof and the other layer facing away from the roof. Preferably the length of the layer facing the roof substantially corresponds to the distance between the roof ridge and the eaves. The layer facing the roof is secured to the roof, while the layer facing away from the roof is releasably fastened to the layer facing the roof. The once-folded web of fabric may be integrated as part of the roof so that in case of fire the top layer can be unfolded and draped over the eaves to protect the exterior of the structure down to the ground. This system ensures secure fastening of the structured cladding to the structure and provides expansive protection of the structure's roof and sidewalls from flying sparks and leaping flames.

In another embodiment of the invention, elongated webs of the fabric are arranged in parallel and juxtaposed relation, to form the structured cladding. These webs may either be in overlapping relation or physically connected to each other through the use of fastening means, to form a substantially continuous protective surface.

In yet another embodiment of the invention, the structured cladding comprises a comb-shaped strip structure, including a longitudinally extending base strip. In one preferred application of the system adapted for home or building protection, the base strip is employed along the full length of the roof ridge. The structured cladding further comprises a plurality of zinc strips juxtaposed or overlapping, and extending perpendicularly from the base strip. Preferably the unfolded zinc strips extend to and beyond the eaves to reach the ground surface immediately adjacent the structure, thereby extending continuously from the ridge of the structure's roof to the ground. The unrolled or unfolded zinc strips may thus be dimensioned to reach the ground adjacent the structure when the base strip is arranged along the ridge of a structure roof.

In yet another embodiment of the invention, the structured cladding in the stowed condition is accommodated in a container located either on the foundation, the roof, or the lateral edge of the exterior sidewall of the object. Alternatively, the container for the structured cladding may be located on or in the ground immediately surrounding the object or structure. Preferably the container is made of aluminum, wood or plastic material for all-weather durability.

In yet a further embodiment of the invention, a hoisting mechanism is provided for hoisting the stowed and undeployed structured cladding into the active and deployed condition, providing protection for the object. The hoisting mechanism comprises a guide attached to the exterior of the object, extending transversely to or longitudinally along the object. As an alternative, the guide may also extend substantially horizontally to and surround at least part of the object. When the system is used for a structure having a roof, the guide may extend along a roof ridge and, where necessary, or appropriate, along the gable structure of the roof.

In another preferred aspect of the invention, the guide maintains the structured cladding in spaced relation from the exterior surface of the object. This is especially advantageous in that it makes for less effort being needed to hoist the structured cladding. In addition, the air layer between the cladding and the exterior surface of the object provides additional insulating protection from extremely high temperatures.

In still another preferred aspect of the invention, the guide for deploying the structured cladding comprises at least one rope, cable, rod, or rail, having at least one end or portion connected to the exterior of the object. Preferably if a rope is employed, it is constructed from a wire material, to provide adequate fire resistant properties. Pulleys may also be used advantageously in combination with rope or cable, to provide low resistance to pulling forces necessary to erect the structural cladding. If rods or rails are utilized as a guide, captive rollers or loop connectors can be used to provide a low resistance slidable interconnection between the cladding and the rod or rail during deployment.

In yet another further embodiment of the invention, when the structured cladding is in its active protective condition, the cladding rests over the exterior side of the guide facing away from the object. Alternatively, or in combination with the foregoing, the structured cladding may be draped along the guide, in an opened or closed condition.

The hoisting mechanism may also include drive means for manual and/or motorized operation of the mechanism hoisting the structured cladding. In this arrangement, the drive means may be located in a fixed location, adjacent the object to be protected, particularly by being sunk into the ground. It is apparent that any motorized drive means employed could readily be provided with wireless or hard wired remote control, and that this remote control feature could also be triggered automatically upon the detection of an approaching fire.

In another further embodiment of the invention, the edge of the structured cladding facing the ground adjacent the object may be provided with a plurality of eyelets for securing the structured cladding to the ground. In this arrangement, the system made in accordance with the invention may feature hooks, pegs or anchoring fasteners interconnected to the eyelets, for securing the structured cladding to or adjacent the ground.

As yet another feature of the invention, a watering system may be provided between the structured cladding and the exterior of the object to be protected. For example, this watering system may comprise a conduit system provided with a plurality of jet nozzles or sprinklers distributed along its length. The nozzles may be arranged so that they jet water away from the exterior of the object in the direction of the structured cladding to wet the structured cladding and improve its heat resistant properties.

In yet another further embodiment of the invention, the conduits of a watering system may be connected to or disposed within the structured cladding to distribute the water to the nozzles located between the structured cladding and the exterior of the object. In this arrangement, the jetting nozzles may also be secured to or integrated within the structured cladding, thereby simplifying the connection between the water supply conduit and the jetting nozzles.

Alternatively, the jetting nozzles may be attached to the exterior of the object, while the conduit remains integrated within the structured cladding. This arrangement would require an interconnection between the jetting nozzles and the conduit when deploying the structured cladding over the object.

As a final example, it will be appreciated that the entire watering system may also be structurally integrated to the exterior of the object.

In addition the invention relates to a method of forming fire protection for an object directly exposed to the elements involving prefabricating a structured cladding of flexible fireproof material for attachment to an exterior of the object substantially to conform with the exterior size and configuration of at least a portion of the object. In accordance with the invention, the method involves stowing the structured cladding in a passive stowed condition in the vicinity of and/or on the object in which the prefabricated structured cladding is rendered compact for stowage. Preferably, the structured cladding is rolled up and/or folded, to assume the stowed condition.

In a preferred embodiment of the invention in the stowed condition, the structured cladding is located along a roof ridge. Upon deployment into the active protective condition, the structured cladding is expanded in size, to extend from the ridge towards and preferably beyond the eaves.

In another preferred aspect of the invention, the structured cladding is folded such that in a first unfolding action, the structured cladding is deployed along the roof ridge to form a longitudinal strip along the roofridge. Then, in a subsequent second unfolding action, the structured cladding is deployed transversely to the roof ridge down to the eaves of the roof to form a plurality of transverse strips covering the roof.

Preferably in its active protective condition, the structured cladding is secured to the ground adjacent the object. This step is undertaken not only to protect the sides and sidewalls of the object, but also to prevent the structured cladding from blowing around and possibly exposing the object under strong wind conditions.

In still another further embodiment of the invention in its stowed condition, the structured cladding is located on a foundation on one side of the structure. Upon being deployed into the active protective condition, the structured cladding is first hoisted to the structure's roof ridge, and then it is further hoisted over the ridge to extend protection to the other side of the roof.

In addition, the structured cladding may also be deployed from a passive stowed condition into an active protective condition like a drape. In this manner, the structured cladding is adapted to cover and protect at least one vertical side of the object. However, it is apparent that the drape may be extended so that it circumscribes the object to form a closed, ring-like structure.

It will be appreciated that the method in accordance with the invention can be implemented in accordance with the functioning principle of the system in accordance with the invention. Likewise the system in accordance with the invention can function in accordance with the method of the invention.

Further aspects, features, and embodiments of the invention will now be disclosed, with reference to the appended drawings.

### BRIEF DESCRIPTION OF THE DRAWINGS

FIG. 1 is a perspective view of a structure provided with a first embodiment of a fire protection system made in accordance with the teachings of the present invention;

FIG. 2 top plan view of an array of a plurality of webs of fabric arranged to form structural cladding in a rectangular configuration;

FIG. 3 is a perspective view of a structure incorporating another embodiment of the fire protection system, showing the structured cladding deployed on the roof and gable wall of the structure;

FIG. 4 is a perspective view of a structure incorporating yet another embodiment of the fire protection system, showing structured cladding extending from the ridge of the roof down to the adjacent ground surface and being secured thereto;

FIG. 5 is a perspective view of a structure incorporating yet another embodiment of the fire protection system, showing the structured cladding in a stowed and undeployed condition, rolled up adjacent the ridge of the roof; and,

FIG. 6 is a perspective view of a structure incorporating yet another embodiment of the fire protection system, showing the structured cladding in a partially deployed condition, being hoisted onto the roof through the use of wire ropes or cables passing over the wall and roof structure.

### REFERENCE NUMERALS

To assist in the reading and comprehension of the discussion to follow, a listing of the Reference Numerals used herein is provided:
1 house
3 longitudinal wall
5 gable wall
7 saddle roof
11 ridge
13 gable edge
15 eaves
17 short leg
19 fire protection system
21 container
23 structured cladding
25 base strip
27, 29, 31 transverse strips
33 arrows
41 drape
43 wire rope
47 eyelets
49 anchor
51, 53 webs of fabric
53a roof facing layer
53b facing away layer
61 cladding roll
73, 75, 77, 79 cable/rope structures
I first fold direction
II second fold direction

### DETAILED DESCRIPTION OF THE PREFERRED EMBODIMENT

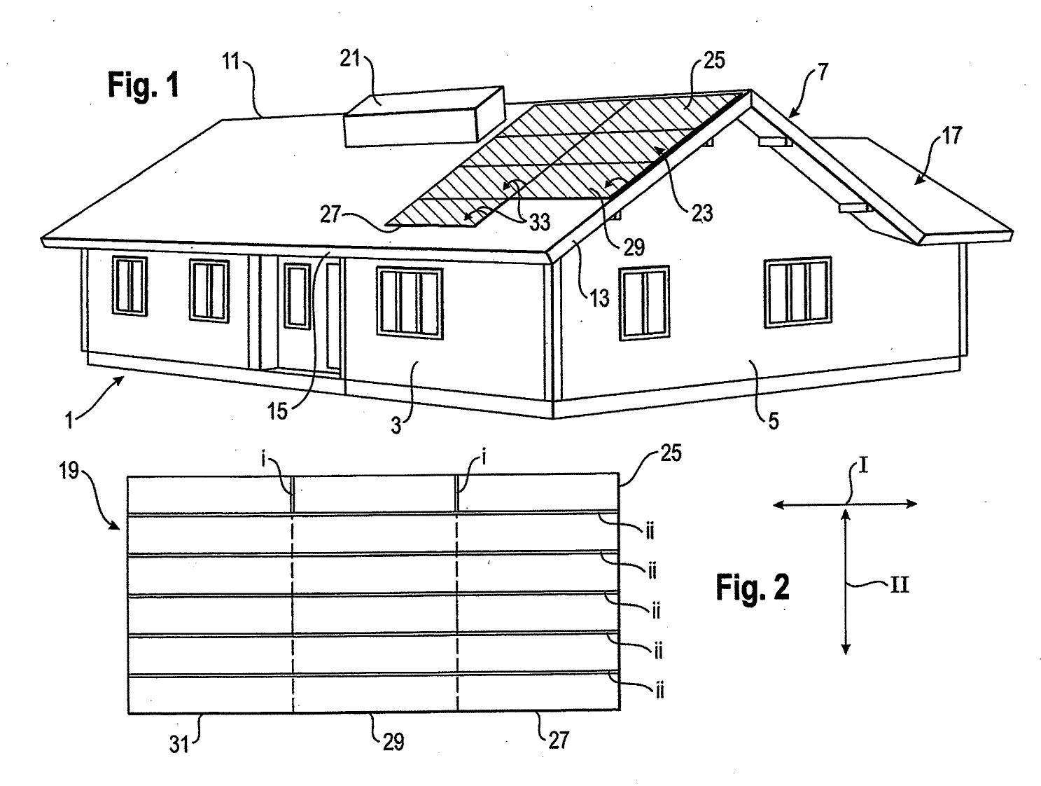

Turning now to FIG. 1, a structure or house 1 has two longitudinal walls 3 with windows and a door, two gable walls 5 and a saddle roof 7 defined by a ridge 11 as well as a gable edge 13 and eaves 15. In plan view, the house 1 is L-shaped with a long leg and a short leg identified in FIG. 1 by the reference numeral 17. The short leg 17 too features a saddle roof as well, but it is lower in elevation.

Although the explanation to follow, describing the various aspects, features, and embodiments of the invention, shows applications involving a structure or house, it should be understood that any object may be protected from destructive elements by practicing the invention herein. Thus, without limitation, other objects such as detached garages, out structures, mobile homes, trailers, recreational vehicles, motor vehicles, motorcycles, or free-standing gas or propane tanks may likewise be protected by utilizing the fire protection system 19 of the present invention.

In its stowed condition, the fire protection system 19 may be stored inside a container 21, preferably made from aluminum to provide durability from the weather. Container 21 is strategically located adjacent ridge 11 of the saddle roof 7, for convenient deployment of system 19 should the need arise. By folding the flexible fabric comprising fire protection system 19 into a compact rectangular configuration, system 19 may be accommodated within the volume of container 21.

To deploy the fire protection system 19 from the stowed condition to the active protective condition, the system needs to be unfolded and arranged so that it covers at least a portion of house 1.

Referring now to FIG. 2, fire protection system 19 comprises a structured cladding 23 formed by an expandible fire protection blanket which may be partly folded and partly segmented into individual parts or components. In FIG. 2, the creases are indicated by double lines while a segment location is indicated by a dashed line.

Shown in FIG. 2 is the folded and partly cut blanket fully deployed, featuring a contiguous base strip 25 deployed in a first fold direction I formed by a triple layer fold interconnected by creases made in accordance with the first fold direction I. Extending from each folded layer of the base strip 25 are three transverse strips 27, 29, 31. These strips extend in a second fold direction II which is perpendicular to the first fold direction I. The longitudinal edges of the transverse strips 27 to 31 may be contiguous to each other or they may overlap. The transverse strips 27, 29 are folded in the second fold direction II, forming creases in accordance with the second fold direction II which are located between the individual folded layers.

In FIG. 1 the structured cladding 23 is depicted only partly unfolded, or deployed. Two folded layers of the base strip 25 are unfolded, the transverse strips 27, 29 located crosswise thereto are unfolded partly towards the eaves 15.

To deploy the fire protection system 19 over the house 1, the folded structured cladding is first spread open on the ridge 11 along the base strip 25 along the ridge 11. Then, the individual transverse strips are unfolded towards the eaves 15 as indicated by the arrows 33. In this arrangement the transverse strips 27 to 31 are configured long enough to overlap the eaves 15 and extend down to the ground.

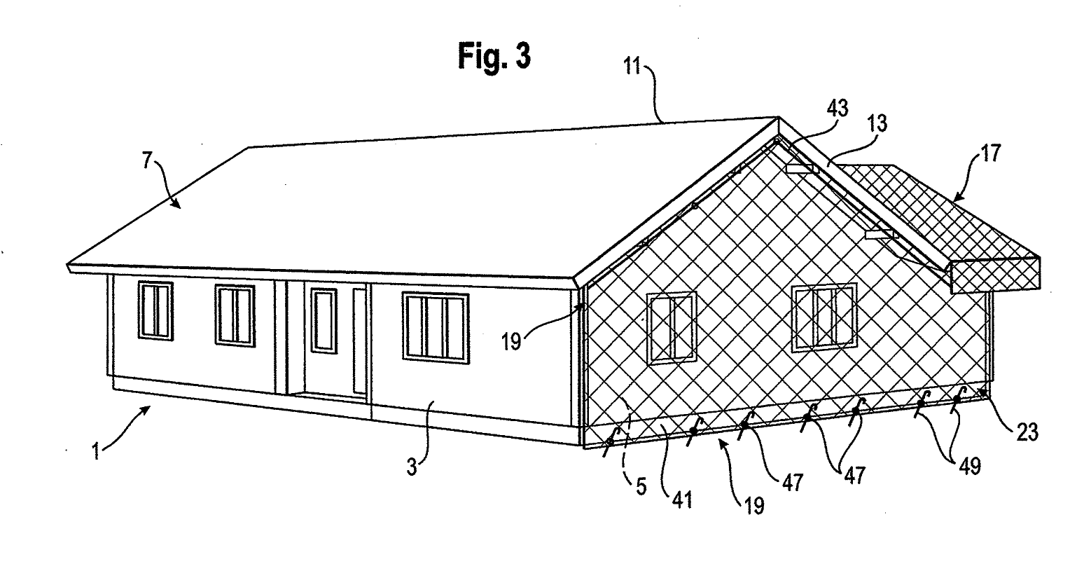

Referring now to FIG. 3, there is illustrated an alternative embodiment of the fire protection system 19 in which the structured cladding 23 is adapted to surround at least a portion of the house 1. The structured cladding in this arrangement comprises a drape identified by reference numeral 41. The drape 41 is hung and held in place along one of the gable edges 13 over a wire rope 43. As is evident from FIG. 3, rope 43 is suspended from and strung along edges 13, so that support drape 41 fully covers the gable wall 5.

It should also be noted from FIG. 3 that the saddle roof for the short leg 17 of the roof of house 1 is already covered by a web of the structured cladding 23. It is for this reason that the drape 41 does not need to reach fully down to the ground surface.

At its lower edge facing the ground, the drape 41 is provided with a plurality of metal eyelets 47 through which the drape 41 is secured to the ground. This is accomplished with the aid of anchor fasteners 49 which have a restraining hook on one end and another end penetrating the ground.

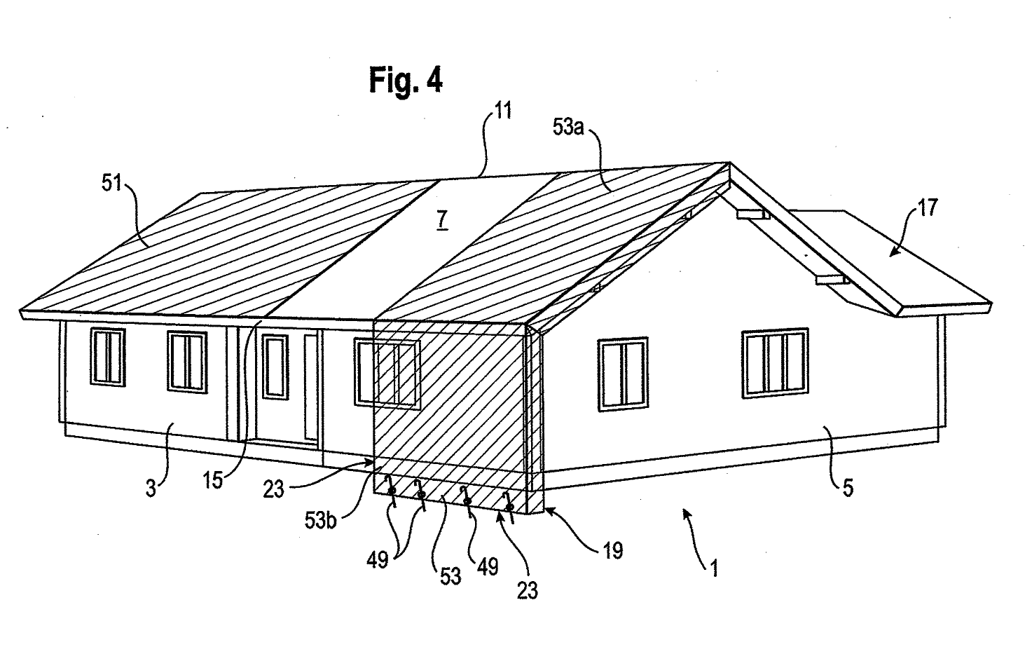

Referring now to FIG. 4, there is illustrated yet another alternative embodiment of the fire protection system 19. In this embodiment, the structured cladding 23 may be formed by a plurality of two folded layer webs of fabric. By way of example, only two webs, web 51 and web 53, are shown in FIG. 4. It is to be understood that by combining and adding other webs of the appropriate size, configuration, and location, house 1 may be entirely covered and protected.

In a stowed condition, webs 51 and 53 comprise two layers of fabric folded one over the other. It should be noted that in FIG. 4, web 53 is shown in the active or deployed condition, providing fire protection for house 1. In contrast, web 51 is shown in the passive, stowed condition. When stowed, web 51 provides protection for the underlying portion of the saddle roof 7, but not for the longitudinal wall 3.

The two layers of fabric forming webs 51 and 53 include a roof facing layer 53a which is affixed to the saddle roof 7. A second layer 53b drapes down to the ground from the eaves 15 when a web is deployed, in the active protective condition. Thus, if the house is faced with a dangerous fire condition, layer 53b facing away from the roof is released from the roof facing layer 53a and allowed to drop down to the ground as shown in FIG. 4.

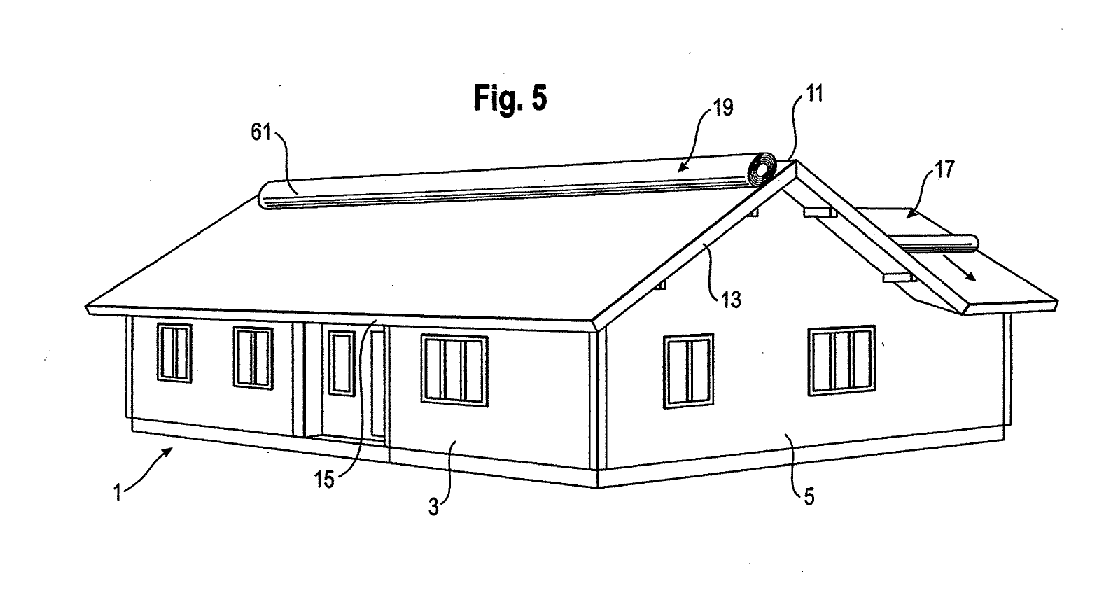

Referring now to FIG. 5, another embodiment of the fire protection system 19 is disclosed. In this construction, the structured cladding 23 is rolled up to assume a stowed condition. The cladding roll 61 extends over the full length of the ridge 11 of the saddle roof 7. Preferably, for each half of the saddle roof 7, a cladding roll 61 is provided. In addition, cladding rolls 61 are provided for either side of the short leg 17 of house 1.

To deploy the fire protection system 19 into its protective condition, the cladding roll 61 is unrolled to the eaves 15 and then to the ground. Thus, the full extent of the deployed structured cladding 23 is larger than the inclined dimension of the roof 7 from the ridge 11 to the eaves 15 plus the height of the eaves 15 off the ground.

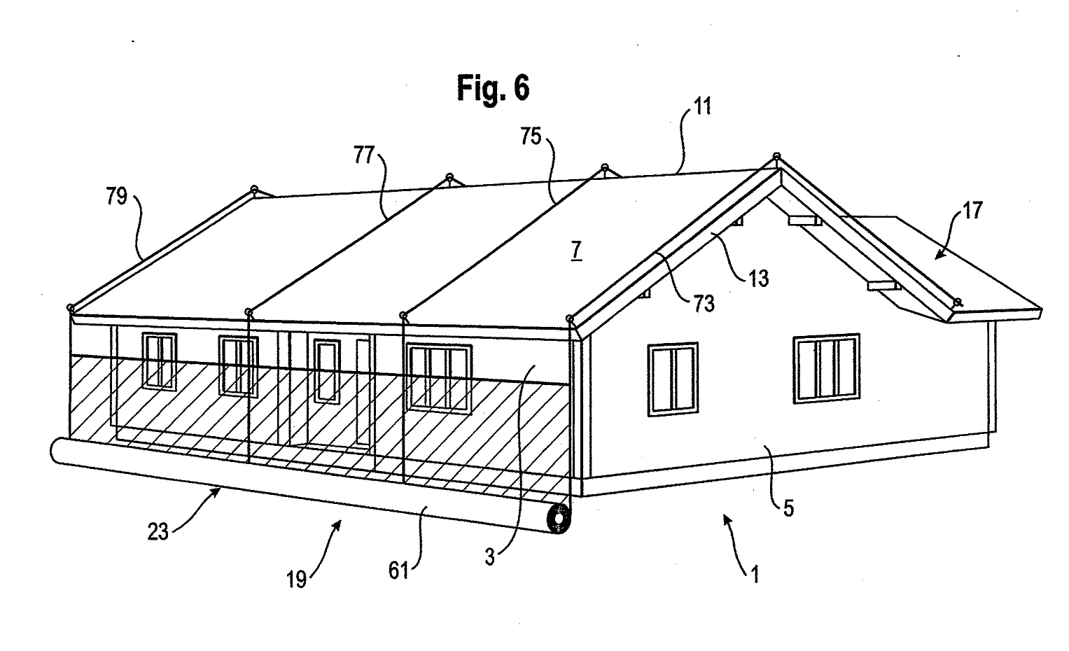

Referring now to FIG. 6, yet a further embodiment of the fire protection system 19 is disclosed. FIG. 6 shows the structured cladding 23 in a partly deployed condition. The fire protection system 19 may also include a hoisting mechanism formed by cable structures 73, 75, 77, 79 extending over the house 1 in transverse fashion. Each cable structure 73 to 79 comprises a tensioned cable as well as a plurality of guide eyelets secured to the exterior of the structure 1. When unrolled, the structured cladding 23 is hoisted along and over the cables and guided over the house 1 to the opposite side. For this purpose, preferably a drive means (not shown) is provided, which may be powered manually or motorized. The guide ropes or cables are located spaced away from the saddle roof 7 and the exterior of the house 1 so that contact between the structured cladding 23 and the house 1 is avoided.

It is understood that the aspects, features, and embodiments of the invention as disclosed in the above description, in the drawings, and as claimed herein, may be essential to achieving the invention both by themselves or in any combination thereof.

What is claimed is:

1. A system for protecting an object having an exterior which is directly exposed to the destructive elements of an outdoor fire, characterized by a structured cladding of flexible, fireproof material attached to or overlying the exterior of the object in spaced relation, said structured cladding being prefabricated substantially or at least correspondingly dimensioned to conform with the outer shape of the object and is capable of being deployed from a passive stowed condition in which the structured cladding is rendered compact in relation to the object, into an active protective condition in which the structured cladding assumes an expanded configuration, to cover at least a portion of the object.

2. The system as set forth in claim 1, characterized in that the fireproof material withstands heat within a range extending from approximately 660° F. (350° C.) to approximately 1100° F. (600° C.).

3. The system as set forth in claim 1, characterized in that the fireproof material is a fabric of silicated fibers.

4. The system as set forth in claim 1, characterized in that the fireproof material comprises glass fibers.

5. The system as set forth in claim 1, characterized in that the fireproof material is formed by a high-temperature protective blanket comprising isoTHERM® 1000, isoTHERM® 800, isoTHERM® HT, isoGLAS®, isokerum®, and isoTECH® preox needle-punched nonwovens, CEPRO® KRONUS, CEPRO® ATLAS, CEPRO® PALLAS, CEPRO® HERCULES, CEPRO® SIRIUS and CEPRO® OLYMPUS, proMEGA, proFIRE, proFEEK and proSAFE and/or Haceram fiber matting.

6. The system as set forth in claim 1, characterized in that the structured cladding is formed by at least one web of fabric which in the stowed condition is rolled up or folded together.

7. The system as set forth in claim 6, characterized in that said web of fabric in its stowed condition is folded such that when deployed flat its extent is smaller or equal to the surface extent of a roof of the object and a layer of the folded web of fabric facing the roof is secured to the roof, at least one further layer being releasably arranged facing the roof so that for the protective condition surface areas of the object uncovered by the web of fabric can be covered.

8. The system as set forth in claim 6, characterized in that in its stowed condition the web of fabric comprises at least one two-layer fold, the length of which is larger than the extent of a roof of a structure from the ridge to the eaves plus the height of the eaves from the ground adjoining the structure.

9. The system as set forth in claim 6, characterized in that at least two webs of fabric are arranged in parallel relation, and in which said two webs are connected to each other to form said structured cladding.

10. The system as set forth in claim 1, characterized in that the structured cladding comprises a base strip extending longitudinally and including a plurality of strips extending substantially perpendicular to said base strip.

11. The system as set forth in claim 10 in which the object is a structure, characterized in that the base strip is fitted to conform to the length of the roof ridge of the structure.

12. The system as set forth in claim 11, characterized in that the strips are dimensioned long enough to reach the ground adjoining the structure when the base strip is arranged along the roof ridge of the structure.

13. The system as set forth in claim 1, characterized in that the structured cladding in the stowed condition is accommodated in a container sited on a foundation of the object, or on a roof of the object, or on a lateral edge of a vertical exterior portion of the object.

14. The system as set forth in claim 13, characterized in that the container is sunk in the ground adjacent the structure.

15. The system as set forth in claim 1, characterized in that a hoisting mechanism is provided for hoisting the stowed structured cladding into the active protective condition, said hoisting mechanism comprising a guide attached to the exterior of the object along which the structured cladding is to be hoisted and expanded over the object.

16. The system as set forth in claim 15, characterized in that the guide maintains the structured cladding in spaced relation from the exterior of the object.

17. The system as set forth in claim 15, characterized in that the guide comprises cable means connected to the exterior of the object.

18. The system as set forth in claim 15, characterized in that in the active protective condition the structured cladding is slidably attached to the guide.

19. The system as set forth in claim 15, characterized in that the guide extends substantially horizontally about at least part of the object.

20. The system as set forth in claim 15, characterized in that the hoisting mechanism further comprises drive means for hoisting the structured cladding.

21. The system as set forth in claim 1, characterized in that at its one edge facing the ground adjoining the object the structured cladding includes eyelets for securing the structured cladding to the ground.

22. The system as set forth in claim 1, characterized in that provided between the structured cladding and the object is a watering system, said watering system comprising at least one conduit connected to a source of water and nozzles hydraulically connected to said conduit jetting water in the direction of the structured cladding.

23. A system for protecting an object having an exterior which is directly exposed to the destructive elements of an outdoor fire, comprising a structured cladding of flexible, fireproof material attached to or overlying the exterior of the object in spaced relation, said structured cladding being prefabricated substantially or at least correspondingly dimensioned to conform with the outer shape of the object and is capable of being deployed from a passive stowed condition in which the structured cladding is rendered compact in relation to the object, into an active protective condition in which the structured cladding assumes an expanded configuration, to cover at least a portion of the object.

24. A method of forming fire protection for an object directly exposed to the elements such as an immobile or mobile structure such as a mobile home, car, truck or the like comprising the steps of:
prefabricating a structured cladding of flexible fireproof material for attachment to an exterior of the object substantially to conform with the exterior of the object and stowing the structured cladding in a passive stowed condition in which the prefabricated structured cladding is rendered compact.

25. The method as set forth in claim 24, characterized in that when a fire occurs the structured cladding is deployed from a passive stowed condition into an active protective condition in which the structured cladding is expanded to cover at least a portion of the object.

26. The method as set forth in claim 24, characterized in that for the stowed condition, the structured cladding is rolled up.

27. The method as set forth in claim 24, characterized in that for the stowed condition, the structured cladding is folded.

28. The method as set forth in claim 25, characterized in that in the stowed condition the structured cladding is located along a roof ridge, the structured cladding on being deployed into the active protective condition extending at least from the ridge to the eaves.

29. The method as set forth in claim 28, characterized in that in a first unfolding action the structured cladding is deployed along the roof ridge to form a longitudinal strip along the roof ridge and then is a subsequent second unfolding action is deployed crosswise to the roof ridge down to the eaves of the roof to form a plurality of transverse strips covering the roof.

30. The method as set forth in claim 25, characterized in that in its active protective condition the structured cladding is secured to the ground adjoining the object.

31. The method as set forth in claim 25, characterized in that in its stowed condition the structured cladding is located on a foundation on one side of the structure, the structured cladding in being deployed into the active protective condition being hoisted to a roof ridge and beyond to an opposite side.

32. The method as set forth in claim 25, characterized in that the structured cladding is deployed from the stowed condition to the protective condition like a drape to cover at least one vertical side of the object.

33. The method as set forth in claim 25, characterized in that the structured cladding is wettened, particularly jetted with a liquid, such as water.
